(19) United States
(12) Patent Application Publication
(10) Pub. No.: US 2014/0238250 A1
(43) Pub. Date: Aug. 28, 2014

(54) Microwavable Heating Element and Composition

(71) Applicant: WKI Holding Company, Inc., Rosemont, IL (US)

(72) Inventors: John Gephart, Corning, NY (US); Rick Lugen, Painted Post, NY (US); Randy Soibel, Chicago, IL (US); Steven Risser, Reynoldsburg, OH (US); Megan Moore, Hilliard, OH (US); Erik Edwards, Gahanna, OH (US); Elvin Beach, Columbus, OH (US)

(73) Assignee: WKI Holding Company, Inc., Rosemont, IL (US)

(21) Appl. No.: 14/177,330

(22) Filed: Feb. 11, 2014

Related U.S. Application Data
(60) Provisional application No. 61/770,866, filed on Feb. 28, 2013.

(51) Int. Cl. A47J 36/24; H05B 6/64

(52) U.S. Cl. CPC A47J 36/2494; H05B 6/6491
USPC 99/483; 219/759

(57) ABSTRACT

Disclosed is a microwavable heating element and thermal storage composition for the controlled storage and release of thermal energy to a thermal mass. The microwavable heating element can be used in conjunction with a warming trivet. One disclosed warming trivet includes a housing, a heating element arranged within the housing and made of a matrix material and a microwave susceptor suspended within the matrix material, and an insulation layer disposed between the heating element and the housing, the insulation layer being configured to insulate the housing from thermal energy emitted by the heating element.

### CROSS-REFERENCE TO RELATED APPLICATION

This application claims the benefit of and priority to U.S. Provisional Patent Application No. 61/770,866, filed Feb. 28, 2013, the entire contents of which are incorporated by reference herein.

### BACKGROUND

The present disclosure is related to heating and warming applications and, more particularly, to a microwavable heating element and thermal storage composition for the controlled storage and release of thermal energy to a thermal mass.

In preparing and serving food, maintaining the food at an elevated temperature during its preparation and prior to serving is an integral component of food safety and a pleasurable dining experience. Various heating or warming options for maintaining food at elevated temperatures exist in the marketplace, such as chafing dishes, slow cookers, and warming trays. These various options, however, have several drawbacks. For example, each of these options is relatively bulky and difficult to store. Moreover, slow cookers require electrical power and must, therefore, be located near an electrical outlet. Some chafing dishes and warming trays also require electrical power and therefore exhibit similar drawbacks. Chafing dishes and warming trays that forego electrical power generally rely on an open flame as a heat source, which has its own apparent drawbacks and dangers.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIGS. 1A-1C illustrate various views of an exemplary trivet that may be used to maintain a thermal mass at an elevated temperature for an extended period of time, according to one or more embodiments.

FIGS. 2A and 2B illustrate schematic cross-sectional side views of embodiments of the trivet of FIG. 1, according to one or more embodiments.

FIGS. 3A-3H depict various line graphs that provide test results corresponding to various exemplary heating element samples that may be used in the trivet of FIG. 1, according to one or more embodiments.

### DETAILED DESCRIPTION

The present disclosure is related to heating and warming applications and, more particularly, to a microwavable heating element and thermal storage composition for the controlled storage and release of thermal energy to a thermal mass.

Disclosed herein are various embodiments of a microwavable heating element and thermal storage composition for the controlled storage and release of thermal energy. The material composition of the heating element is selected to provide desired mechanical and thermal properties. The heating element is capable of being used in a variety of applications including, but not limited to, laboratories, medical offices, and home use, where it is desired to keep a thermal mass at an elevated temperature for an extended period of time.

One exemplary application includes the use of the heating element as a trivet that keeps a hot food item warm for an extended period of time. In this exemplary application, some embodiments of the heating element may be configured to keep the food item warmer than about 150° F. (and preferably warmer than about 140° F.) for a time period of at least 30 minutes, but without significantly increasing the temperature of the food item to prevent additional cooking when the food item is initially placed on the heating element. In one embodiment, heating elements disclosed herein can be placed in a microwave oven for heating and then positioned in thermal communication with the food item, typically by positioning the heating element underneath a dish or service piece that contains the food item. Heating elements disclosed herein can also be placed in a conventional oven for warming, although such warming will generally take significantly longer than placing the heating elements in a microwave.

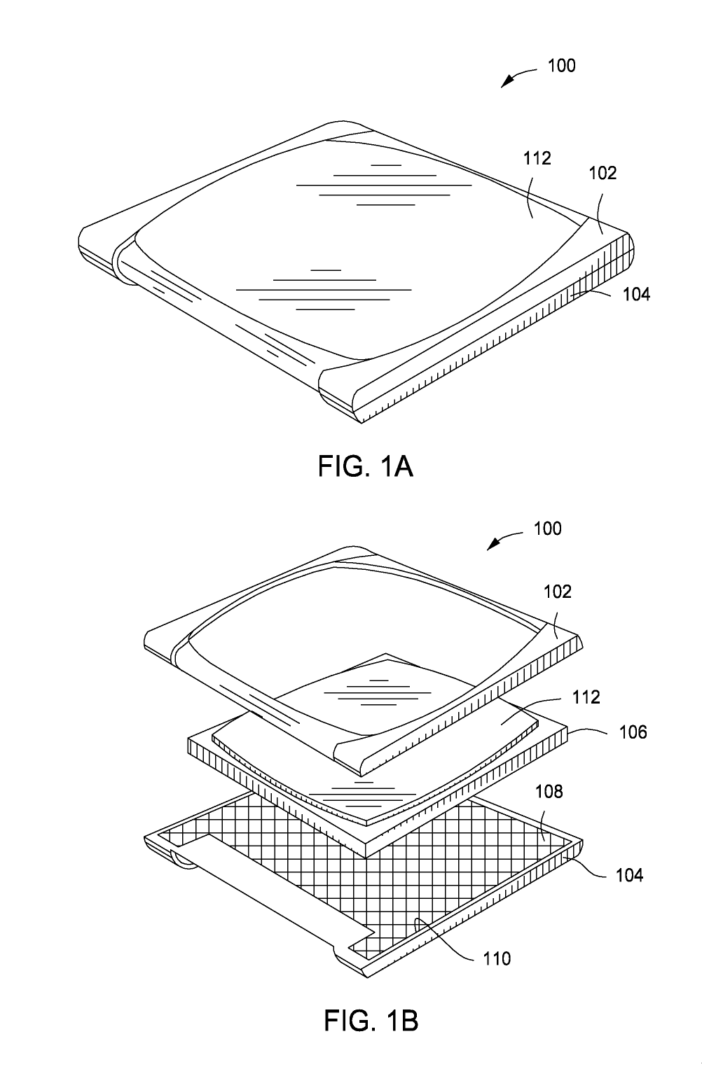

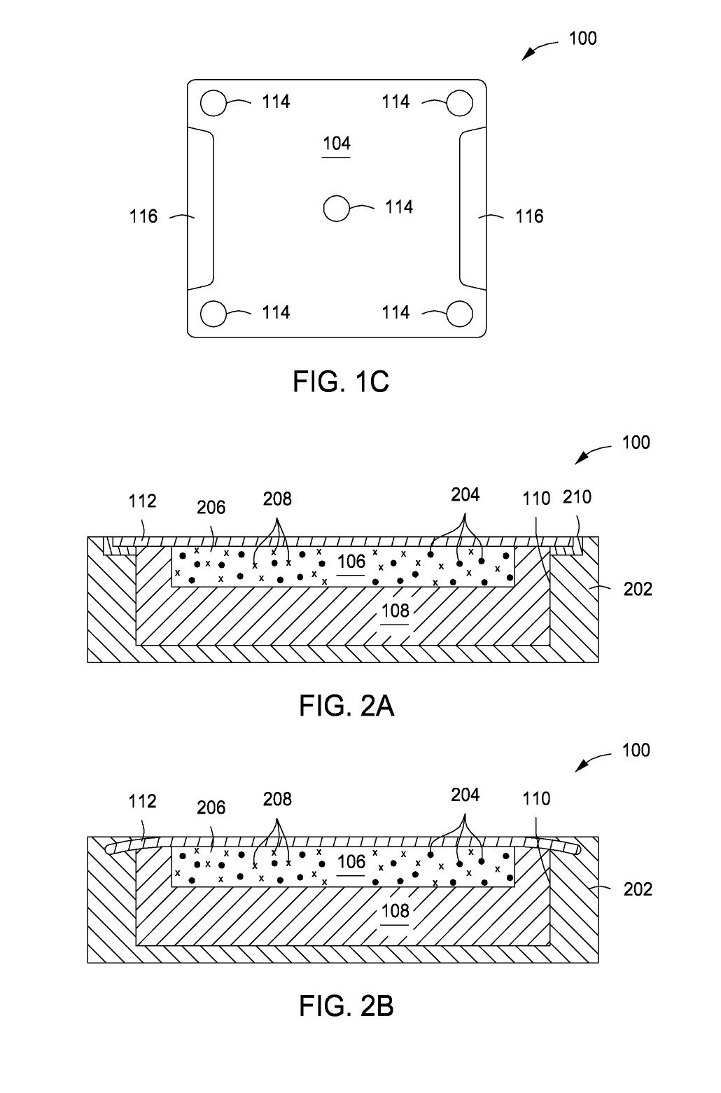

Referring to FIGS. 1A-1C, illustrated is an exemplary trivet 100, according to one or more embodiments. More particularly, FIG. 1A illustrates an isometric view of the exemplary trivet 100, FIG. 1B illustrates an exploded view of the exemplary trivet 100, and FIG. 1C illustrates a bottom view of the exemplary trivet 100. As discussed in greater detail below, the trivet 100 may be used to maintain a thermal mass, such as a food product or item, at an elevated temperature for an extended period of time, according to one or more embodiments.

As depicted, the trivet 100 may comprise a housing that may include an upper frame 102 and a base 104. Together, the upper frame 102 and the base 104 may be configured to receive and otherwise retain a heating element 106 and an insulating layer 108 within the housing. The insulating layer 108 may be received within a cavity 110 defined in the base 104. The insulating layer 108 may function to insulate the bottom surface of the heating element 106 such that any heat emitted from the heating element 106 is directed upwardly toward a thermal mass (not shown) that is to be warmed. The heating element 106 may be positioned on top of the insulating layer 108 and the upper frame 102 may be configured to surround and at least partially receive the heating element 106, thereby generally preventing the heating element 106 from removal from the housing. In this embodiment, the heating element 106 defines a heating contact surface to receive an item for heating. It is contemplated that the heating element 106 may define the direct or indirect heating contact surface. As discussed below, a top layer 112 may be disposed atop the heating element 106 such that the top layer 112 defines the direct heating contact surface and the heating element 106 is the indirect contact surface.

In at least one embodiment, the trivet 100 may further include a top layer 112 disposed atop the heating element 106 and otherwise exposed to the surrounding environment such that the thermal mass may be placed thereon. In some embodiments, the top layer 112 may extend through and otherwise protrude out of the upper frame 102. In other embodiments, however, the top layer 112 may be configured flush with the upper frame 102, without departing from the scope of the disclosure. The top layer 112 may function as a heat transfer layer for transferring heat from the heating element 106 to the thermal mass placed thereon. In this embodiment, the top layer 112 of the heating element 106 defines a direct contact surface to receive an item for heating.

As used herein, the term “thermal mass” may refer to any object or body desired to be maintained at an elevated temperature using the trivet 100 or the heating element 106 individually. In some applications, for example, the thermal mass may be a food product or food item arranged on the trivet 100 (e.g., the top layer 112) or otherwise arranged directly on the heating element 106. As will be appreciated, the thermal mass may or may not be arranged in a corresponding container or vessel (e.g., a pot, a warming dish, etc.). It should be understood that the present disclosure is not limited to food products. In other applications, however, the thermal mass may be any other suitable liquid or solid which a user finds desirable to keep at elevated temperatures.

In some embodiments, as illustrated, the upper frame 102 and the base 104 may be formed in separate structural pieces. In such embodiments, the upper frame 102 may be secured to the base 104 in order to secure the internal components (e.g., the heating element 106, the insulating layer 108, the top layer 112, etc.) therein and otherwise hide the insulating layer 108. The upper frame 102 may be coupled to the base 104 using a variety of attachment methods including, but not limited to, snap fits, mechanical fasteners, adhesives, sonic welding, combinations thereof, and the like. In at least one embodiment, the upper frame 102 may also (or alternatively) be coupled to the heating element 106 using any of the aforementioned attachment methods.

In other embodiments, however, the upper frame 102 and the base 104 may comprise a single structural element that receives and otherwise houses the insulating layer 108 and the heating element 106 therein. In such embodiments, the base 104 and the upper frame 102 may be concurrently over-molded onto or otherwise around the insulating layer 108 and the heating element 106, thereby providing the trivet 100 as a monolithic structure.

As best seen in FIG. 1C, the base 104 may include one or more feet 114 (five shown) engageable with a support surface, such as a table or other planar surface, configured to support the trivet 100 for use. While five feet 114 are depicted in FIG. 1C, those skilled in the art will readily appreciate that more or less than five feet 114 may be employed, without departing from the scope of the disclosure. In some embodiments, the base 104 may further include or otherwise define one or more recessed areas 116 (two shown) extending along opposite sides of the base 104. The recessed areas 116 may prove useful in providing a means for safely handling the trivet 100. In other embodiments, however, the recessed areas 116 may be omitted from the base 104, without departing from the scope of the disclosure.

The upper frame 102 and the base 104 may be made of or otherwise formed of the same material or of different materials. In some embodiments, the upper frame 102 and the base 104 may be made of materials that allow the heating element 106 to thermally expand during operation of the trivet 100. Suitable materials for the upper frame 102 and/or the base 104 include synthetics, such as phenol formaldehyde (PF), syndiotactic polystyrene (SPS), polyphthalamide (PPA), silicone, polycyclohexylenedimethylene terephthalate (PCT), polyethylene terephthalate (PET), polybutylene terephthalate, and polyolefin (such as, for example, polypropylene). In other embodiments, suitable materials for the upper frame 102 and the base 104 may include, but are not limited to, wood, cork, ceramics, microwaveable metals, microwaveable materials, and the like. As will be appreciated, the foregoing materials may be used alone or in combination to form the upper frame 102 and/or the base 104, without departing from the scope of the disclosure.

In exemplary operation of the trivet 100, the heating element 106 may be placed in a microwave oven to warm the heating element 106. Depending on the specific construction and materials used for the trivet 100, the entire trivet 100 may be placed in the microwave to warm the heating element 106, or the heating element 106 may alternatively be removed from the upper frame 102 and the base 104 and placed individually into the microwave for warming.

In embodiments where the entire trivet 100 is placed in the microwave for warming the heating element 106, it may prove advantageous to have the upper frame 102 and the base 104 formed of a material having a relatively low capacity for absorbing microwave radiation and converting it to heat. In such embodiments, for instance, suitable materials for the upper frame 102 and the base 104 may include any thermosetting polymer that is non-reactive to microwave radiation. This construction results in the upper frame 102 and the base 104 remaining relatively cool and safe to handle after the trivet 100 has been heated in the microwave.

In some embodiments, the upper frame 102 and the base 104 may be formed of a material that remains thermally stable to a temperature of at least about 180° F. In other embodiments, the upper frame 102 and the base 104 may be formed of a material that remains thermally stable to a temperature of at least about 300° F. In still other embodiments, the upper frame 102 and the base 104 may be formed of a material that remains thermally stable to a temperature of at least about 480° F.

Referring now to FIGS. 2A and 2B, illustrated are schematic cross-sectional side views of embodiments of the trivet 100 of FIG. 1, according to one or more embodiments. In the illustrated embodiments, the upper frame 102 and the base 104 of FIGS. 1A-1C are cooperatively depicted in FIGS. 2A and 2B as a housing 202.

As illustrated, the insulating layer 108 is arranged within the cavity 110 defined within the housing 202 (e.g., the base 104 of FIG. 1). The insulating layer 108 retains and guides heat, as generally discussed above. More particularly, the insulating layer 108 covers and is otherwise in contact with the bottom of the heating element 106 to promote the transfer of heat from the heating element 106 to the surroundings primarily by way of the top surface of the heating element 106. In some embodiments, as illustrated, the insulating layer 108 may also extend around and otherwise cover portions of the side surfaces of the heating element 106. Accordingly, the insulating layer 108 may functions to keep the bottom and sides of the housing 202 relatively cool. As will be appreciated, this may prove advantageous in avoiding potential damage to the microwave or the surface upon which the warmed trivet 100 is subsequently positioned for use. This may further prove advantageous in reducing the risk of a user burning his or her hand when transporting or moving the warmed trivet 100.

Suitable materials for the insulating layer 108 include, but are not limited to, glass wool, kaowool board, thermal ceramic blankets, glass foam, melamine foam, polyurethane foam, and fiber glass. Although specific configurations may vary, the insulating layer 108 may generally include a thickness that ranges between about ¼ inch to about ½ inch. In some embodiments, the insulating layer 108 is formed of a material having a maximum operating temperature of at least about 250° F.

In some embodiments, the heating element 106 may be made of a composite material composed of at least two constituent components. The first component is a susceptor material 204 that exhibits a relatively high susceptance or capacity to absorb microwave radiation and convert it into thermal energy. The second component is a binder or matrix material 206 that holds or receives the susceptor material 204 and otherwise adds mass to the heating element 106. The matrix material 206 may also serve to reduce the overall temperature of the heating element 106 for a given amount of absorbed microwave radiation.

The susceptor material 204 may be, but is not limited to, metals, metal oxides, metal sulfides, carbon, polymers, combinations thereof, and the like. In some embodiments, the susceptor material 204 used in the heating element 106 may be in the form of multiple strips, wires or metal mesh. In other embodiments, however, the susceptor material 204 used in the heating element 106 may be in powder or pellet form, which can simplify manufacturing by making it relatively easy to evenly distribute the susceptor material 204 throughout the matrix material 206. Specific examples of potentially suitable susceptor materials 204 include, but are not limited to, iron (II, III) oxide (Fe₃O₄), tin dioxide (SnO₂), copper oxide (CuO), silicon carbide (SiC), iron (Fe), aluminum (Al), and carbon (C). In some embodiments, the susceptor material 204 is iron oxide having a particle size of between about 25 and about 50 microns, with a purity of greater than about 90%. Suitable susceptor materials 204 should be capable of obtaining an increase in temperature of between about 200° F. and 500° F. when placed in a 1000 W microwave oven for a period of between 1 and 2 minutes.

The matrix material 206 may include, but is not limited to, thermosetting polymers, thermoplastic polymers, elastomers, and inorganic matrices. Specific examples of potentially suitable matrix materials 206 include polyphenylene sulfide (PPS), polycyclohexylene dimethylene terephthalate (PCT), syndiotactic polystyrene (SPS), silicone, silicone elastomer, polytetrafluoroethylene (PTFE), fluoroelastomer, alumina (Al₂O₃), and cement. The matrix material 206 preferably exhibits a relatively low susceptance and has a maximum operating temperature of at least about 250° F., and in some embodiments has a maximum operating temperature of at least about 480° F.

In some embodiments, the selected matrix material 206 may exhibit a very low thermal conductivity, e.g., less than 1.0 W/mK, and therefore may be too low for use in food warming applications because it prevents sufficient heat transfer from the heating element 106 to the food item (i.e., the thermal mass). Moreover, in many cases the susceptor material 204 may also exhibit a relatively low thermal conductivity, such that the overall thermal conductivity of the combined matrix material 206 and the susceptor material 204 is still too low for food warming applications.

To resolve this issue, the heating element 106 may optionally include a filler material 208 dispersed and otherwise suspended within the matrix material 206. The filler material 208 may exhibit a relatively high thermal conductivity, but that also exhibit a lower capacity, relative to the susceptor material 204, for absorbing microwave radiation and converting it into thermal energy. Specific examples of potentially suitable filler materials 208 include, but are not limited to, magnesium oxide (MgO), aluminum oxide (Al₂O₃), zinc oxide (ZnO), and metal mesh. In some embodiments, the filler material 208 is aluminum oxide having a particle size of between about 25 and about 50 microns, with a purity of greater than about 95%.

Incorporation of the filler material 208 into the matrix material 206, along with the susceptor material 204, adds mass to the heating element 106 and may be configured to increase the overall thermal conductivity of the heating element 106. In some instances, such as in the case where the filler material 208 is metal mesh, the filler material 208 may also improve the durability (e.g., drop resistance) of the heating element 106. In some embodiments, the filler material 208 may be selected to have a susceptance that is lower than a susceptance of the selected susceptor material 204, and a thermal conductivity that is greater than the selected matrix material 206.

In some embodiments, the total thickness of the heating element 106 may be between about 0.2 to about 0.35 inches, including some embodiments in which the total thickness may be between about 0.2 to about 0.28 inches. In some embodiments, total weight of the heating element 106 may be between about 0.9 to about 2 pounds, including some embodiments in which the total weight may be between 1 pound and 1.3 pounds.

As illustrated, the heating element 106 may also optionally include the top layer 112. In some embodiments, the top layer 112 may be integrally formed with the heating element 106. In other embodiments, however, the top layer 112 may be separate from the heating element 106 and otherwise arranged thereon while assembling the housing 202 or the trivet 100. Besides providing a support and heating surface for the thermal mass (e.g., food item), the top layer 112 may further prove useful in preventing the user from inadvertently touching or contacting the susceptor material 204, such as when the heating element 106 is removed from the microwave. As will be appreciated by those skilled in the art, even though the susceptor material 204 is carried or otherwise suspended in the matrix material 206, the temperature of the individual particles or grains of susceptor material 204 can greatly exceed the overall or average temperature of the heating element 106. As a result, the top layer 112 may prove useful in reducing the possibility that a user is burned by preventing the user from directly contacting individual particles or grains of susceptor material 204 that might otherwise be exposed on the surface of the heating element 106.

In some embodiments, the top layer 112 may be integrally formed with or otherwise of the same material as the matrix material 206. The top layer 112 may optionally include a pigment, such as titanium oxide, such that the top layer 112 exhibits a desired color (e.g., white). In at least one embodiment, the top layer 112 is made of a microwave inactive material that does not absorb significant amounts of microwave radiation while the heating element 106 is warmed in the microwave. Accordingly, the top layer 112 may primarily function as a heat transferring layer for conveying heat from the heating element 106 to the thermal mass to be maintained at an elevated temperature or otherwise warmed.

One exemplary technique for forming the top layer 112 includes pouring a small amount of the matrix material 206, optionally including a pigment, into a mold and allowing it to slightly set. The mold can then be filled with the matrix material 206 containing the susceptor material 204 and optionally the filler material 208, followed by curing. The top layer 112 may have a thickness of less than about ⅛ inch. In embodiments where the optional pigment is titanium oxide, the pigment may have a particle size of about 25 to about 100 microns and a purity of at least about 90%.

In other embodiments, including the embodiments depicted in FIGS. 2A and 2B, the top layer 112 may be formed separately from the heating element 106. After being formed, the top layer 112 may be coupled or otherwise attached to the heating element 106 and/or the housing 202. In the embodiment depicted in FIG. 2A, for instance, the top layer 112 is secured to the housing 202 using an adhesive 210. In the embodiment depicted in FIG. 2B, the top layer 112 may alternatively be physically secured within the housing 202 or otherwise molded into the housing 202, without departing from the scope of the disclosure.

When fabricated in accordance with the present teachings, the heating element 106 may possess appropriate ranges of susceptance (e.g., the ability to convert microwave radiation into thermal energy) and thermal conductivity. One limitation relating to susceptibility is the desire to prevent the heating element 106 from getting too hot during a typical warming cycle. For example, too much susceptor material 204 may cause the heating element 106 to get too hot and subsequently release its thermal energy too quickly. On the other hand, if too little susceptor material 204 is included, the heating element 106 may not get hot enough for suitable operation. By adding the filler material 208 and adjusting the relative amounts of the filler material 208, the susceptor material 204, and the matrix material 206, the thermal conductivity and mass of the heating element 106 can be adjusted to achieve appropriate maximum temperatures and relative rates of heat transfer for a particular application, such as keeping food warm over an extended period of time.

In some embodiments, the susceptor material 204 accounts for between about 30% and about 60%, by weight, of the heating element 106. In embodiments that also include the filler material 208, the susceptor material 204 may account for between about 30% and 40%, by weight, of the heating element 106. The filler material 208 may account for between 0% and about 40%, by weight, of the heating element 106, and in some embodiments may account for between about 20% and about 30%, by weight, of the heating element 106.

In certain exemplary embodiments, the heating element 106 may exhibit an overall susceptibility such that the heating element 106 is able to reach a temperature ranging between about 160° F. and about 250° F. after being subjected to microwaves in a 1000 W microwave oven for between 60 and 120 seconds. In some embodiments the heating element 106 is able to reach a temperature equal to, or exceeding, 300° F. after being subjected to microwaves in a 1000 W microwave oven for between 60 and 120 seconds. Lower resultant temperatures generally may not provide adequate warming capacity for the thermal mass, and higher resultant temperatures may result in too much thermal energy being transferred to the thermal mass, which, in the event the thermal mass is a food item, may cause undesirable additional cooking (i.e., overcooking) or browning of the food.

As will be appreciated, similar limitations exist with respect to the desired range of thermal conductivity of the heating element 106. For example, if the thermal conductivity of the heating element 106 is too large, thermal energy will be rapidly transferred from the interior of the heating element 106 to its surface, and then to the thermal mass. If this heat transfer is too rapid, the thermal mass (i.e., food item) may be undesirably cooked instead of being kept warm.

To facilitate a better understanding of the present disclosure, the following examples of preferred or representative embodiments of heating elements 106 are given. In no way should the following examples be read to limit, or to define, the scope of the disclosure.

Referring to Table 1 below, with continued reference to FIGS. 1A-1C and 2A-2B above, several sample heating elements 106 were fabricated and tested to highlight certain aspects (e.g., thermal properties) of differently-made heating elements 106. Samples 1-8 in Table 1 were prepared by adding the stated amounts (by weight percent “wt %”) of the stated susceptor materials 204 and filler materials 208 to the selected matrix material 206. The mixture was then poured into a mold and cured to produce substantially square heating elements 106 having sides measuring approximately 219 mm in length. The total mass and resulting thickness of each sample was determined by the degree to which the mold was filled.

TABLE 1

| | | | | Top | |
|---|---|---|---|---|---|
| | Susceptorr | Filler | Matrix | Layer | Mass (g) |
| Sample 1 | 30 wt % | 20 wt % | Silicone 1 | No | 777.72 |
| | Fe₃O₄ | Al₂O₃ | | | |
| Sample 2 | 30 wt % | 20 wt % | Silicone 1 | No | 384.77 |
| | Fe₃O₄ | Al₂O₃ | | | |
| Sample 3 | 50 wt % | None | Silicone 1 | No | 454.33 |
| | Fe₃O₄ | | | | |
| Sample 4 | 30 wt % | 20 wt % | Silicone 1 | Yes | 429.57 |
| | Fe₃O₄ | Al₂O₃ | | | |
| Sample 5 | 50 wt % | None | Silicone 1 | No | 511.55 |
| | CuO | | | | |
| Sample 6 | 30 wt % | None | Alumina | No | 966.4 |
| | Fe₃O₄ | | | | |
| Sample 7 | 40 wt % | Steel | Cement | No | 880.85 |
| | Fe₃O₄ | Mesh | | | |
| Sample 8 | 30 wt % | 20 wt % | Silicone 2 | No | 422.35 |
| | Fe₃O₄ | Al₂O₃ | | | |

In Samples 1-8 shown in Table 1 above, Silicone 1 is Shin Etsu KE1300T and Silicone 2 is Sylgard 184. An alternative method of making a heating element 106 includes mixing the susceptor material 204 and filler material 208 into the matrix material 206 and then putting the mixture between opposing plates of a hot press. Depending on the specific materials used, this procedure may allow for a smoother surface finish and a thinner final cross section.

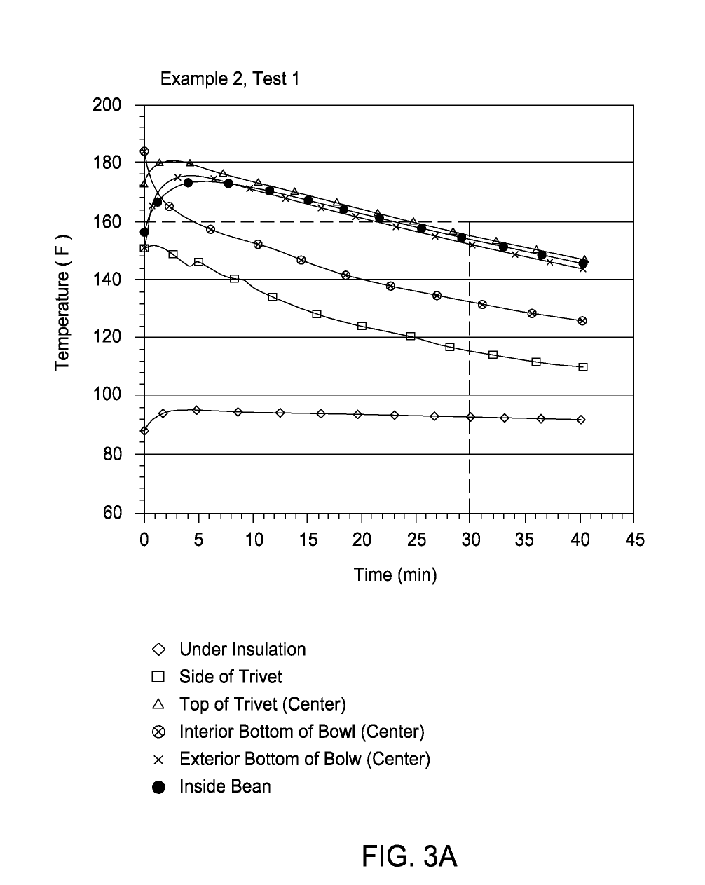

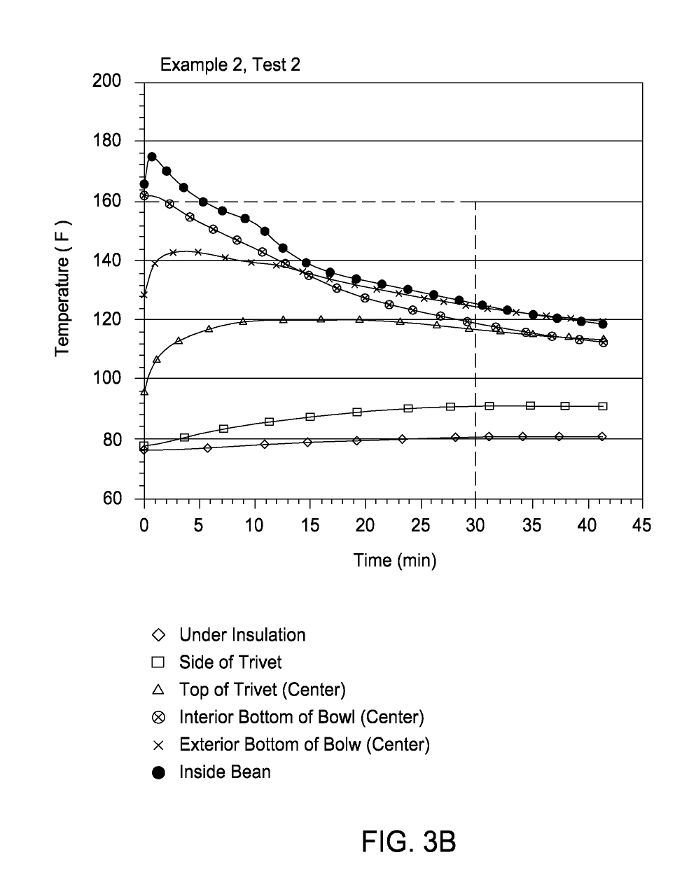

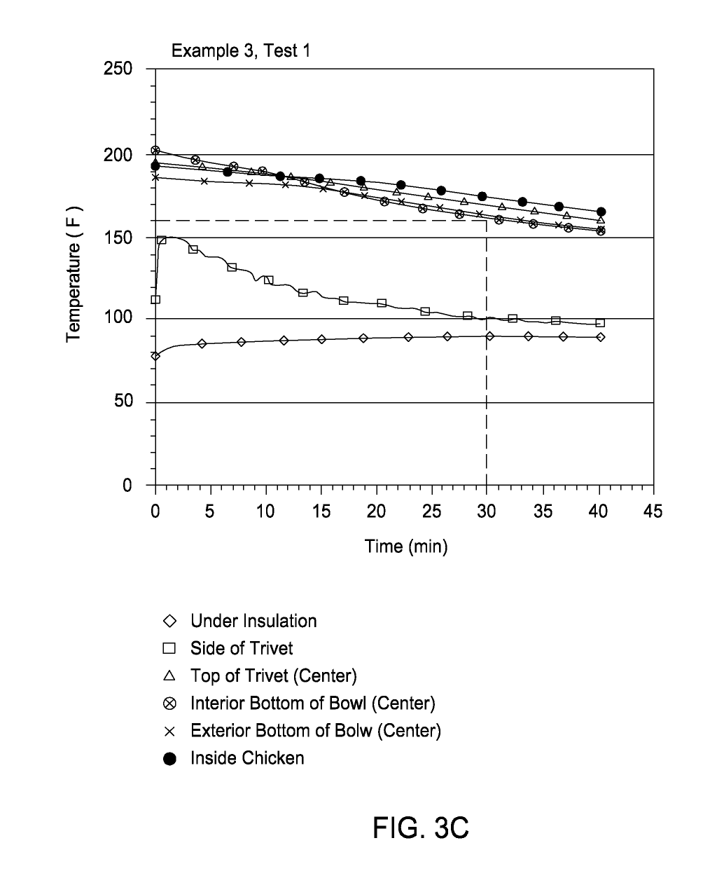

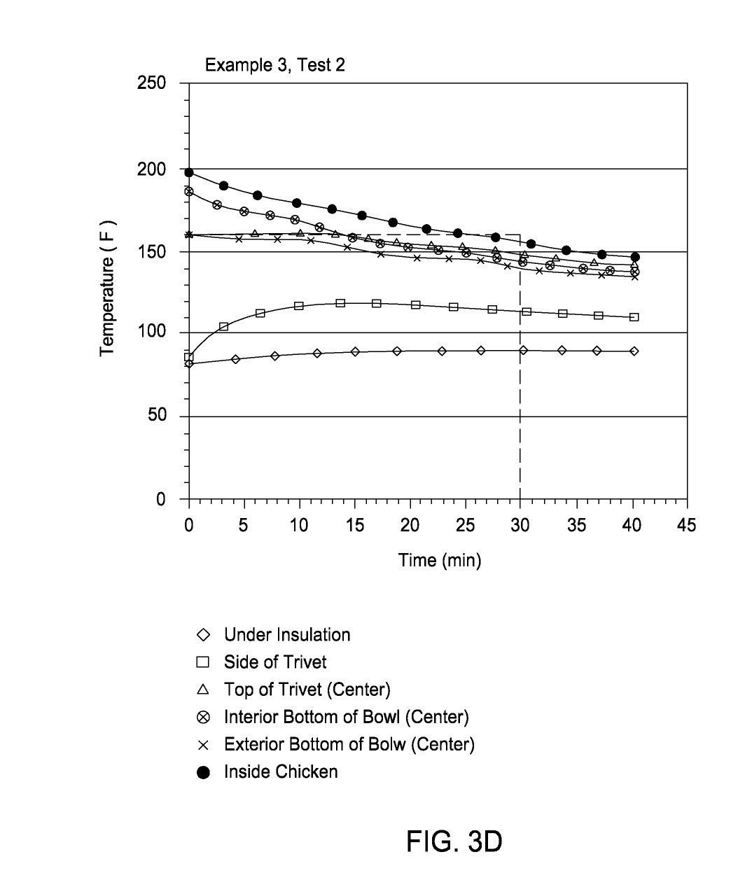

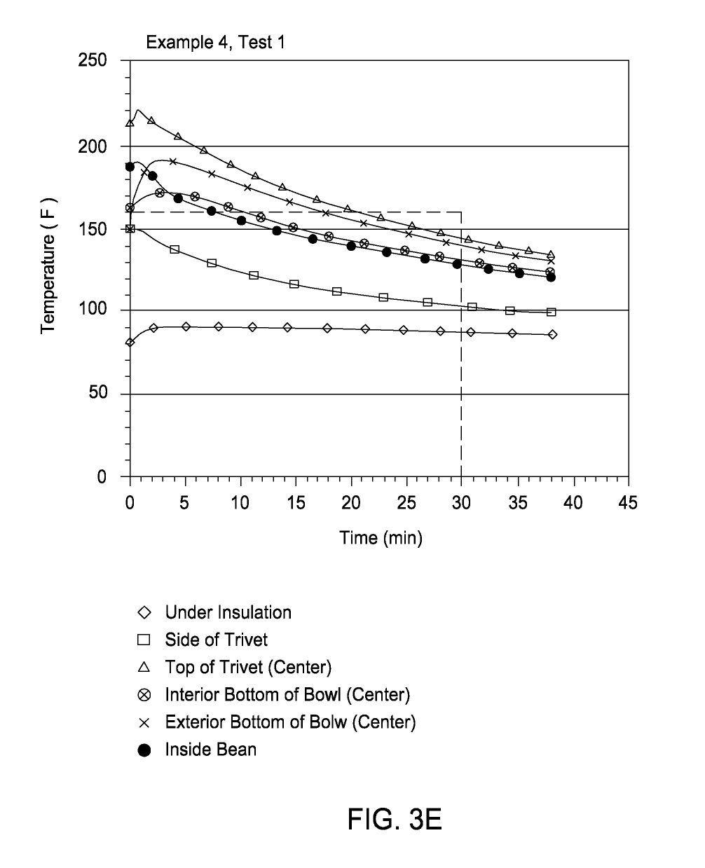

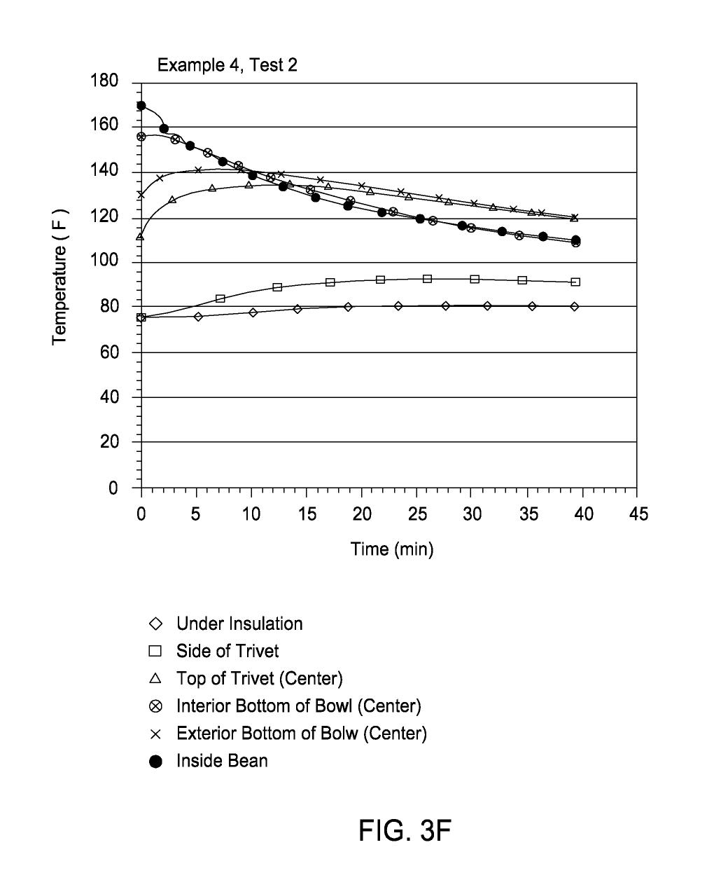

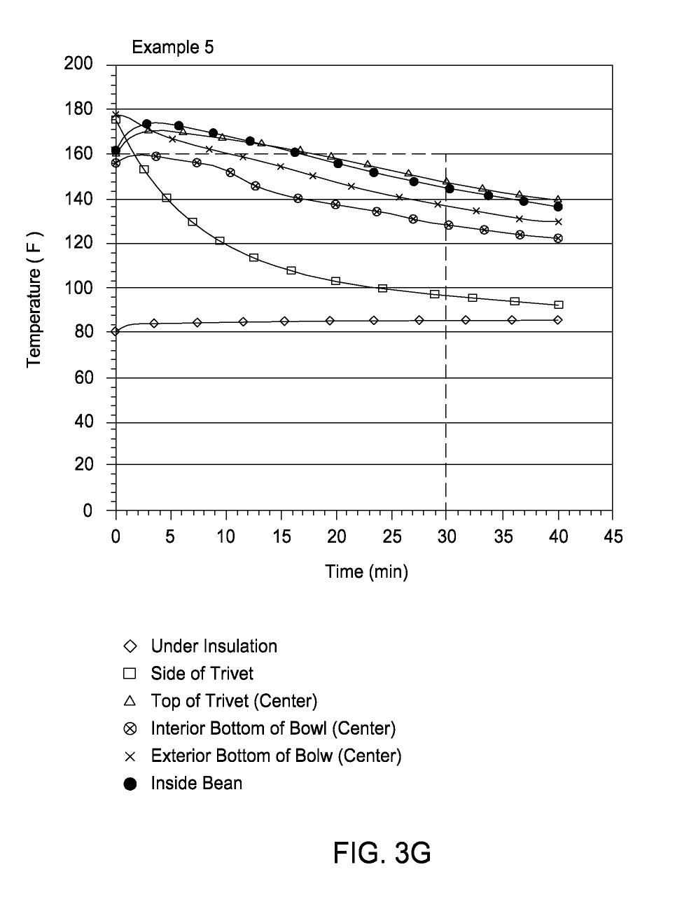

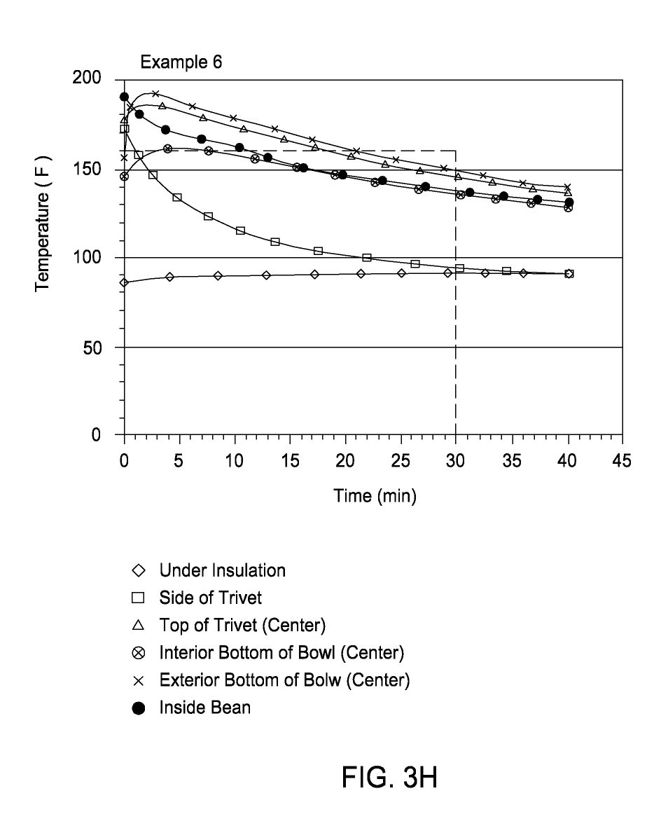

Referring to FIGS. 3A-3H, with continued reference to Samples 1-8 in Table 1, illustrated are line graphs depicting exemplary use of the sample heating elements 106 and otherwise highlight certain aspects and performance criteria thereof:

Example 1. In this example, Samples 2 and 3 were each placed in a 1000 W microwave for 60 seconds. Notably, Sample 2, which contained 20 wt % Al₂O₃ filler material 208, felt noticeably hotter to the touch than did Sample 3.

Example 2. Frozen green beans were cooked in the microwave according to package directions. The beans were then placed in a room temperature 2.5 quart ceramic dish with a lid. Sample 1 was microwaved for 120 seconds in a 1000 W microwave oven, then placed on an approximately ½ inch thick piece of insulation. Thermocouples were placed on the top surface of Sample 1, on the bottom of the ceramic dish, and within a green bean located in the middle of the ceramic dish. The dish containing the green beans was positioned on top of Sample 1 and temperature data was then recorded. The lid was kept on for 10 minutes, removed for 5 minutes, placed back on for 10 minutes, removed for 5 minutes, then replaced. At the end of 30 minutes, the temperature of the monitored green bean was above 154° F. Results of this test are shown in FIG. 3A. A repeat of the test was performed, but without microwaving Sample 1. At the end of the second test, the temperature of the green bean was measured at 125° F. Results of this test are shown in FIG. 3B.

Example 3. In this example, frozen chicken breasts were cooked in a 2.5 quart ceramic dish with a lid in a 350° F. conventional oven until the internal temperature of the chicken exceeded 170° F. Sample 2 was microwaved for 60 seconds in a 1000 W microwave oven, then placed on an approximately ½ inch thick piece of insulation. Thermocouples were placed on the top surface of Sample 2, on the bottom of the ceramic dish, and within a chicken breast located in the middle of the dish. The dish containing the chicken breasts was positioned on top of Sample 2 and temperature data was recorded. The lid was kept on the dish for 10 minutes, removed for 5 minutes, placed back on for 10 minutes, removed for 5 minutes, and then replaced. At the end of 30 minutes, the internal temperature of the chicken was 175° F. Results of this test are shown in FIG. 3C. A repeat of the test was performed, but without microwaving Sample 2. Results of this test are shown in FIG. 3D. As seen in FIG. 3D, at the end of the second test, the temperature of the chicken was less than 154° F., thereby exhibiting a temperature decrease of more than 21° F.

Example 4. In this example, frozen green beans were cooked in the microwave according to package directions. The beans were then placed in a room temperature 2.5 quart ceramic dish without a lid. Sample 3 was microwaved for 90 seconds in a 1000 W microwave oven, then placed on an approximately ½ inch thick piece of insulation. Thermocouples were placed on the top surface of Sample 3, on the bottom of the ceramic dish, and within a green bean located in the middle of the dish. The dish containing the green beans was positioned on top of Sample 3 and temperature data was recorded. Results of this test are shown in FIG. 3E. A repeat of the test was performed, but without microwaving Sample 3. Results of this test are shown in FIG. 3F. As indicated in FIG. 3F, the temperature of the green bean was almost 15° F. cooler at the end of the second test as compared to the temperature of the green bean at the end of the first test.

Example 5. In this example, frozen green beans were cooked in the microwave according to package directions. The beans were then placed in a room temperature 2.5 quart ceramic dish with a lid. Sample 4 was microwaved for 120 seconds in a 1000 W microwave oven, then placed on an approximately ½ inch thick piece of insulation. The dish containing the green beans was positioned on top of Sample 4 and temperature data was recorded. Results of this test are shown in FIG. 3G. As indicated in FIG. 3G, the green beans remained at a temperature greater than or equal to about 135° F. for a period of 30 minutes.

Example 6. In this example, frozen green beans were cooked in the microwave according to package directions. The beans were then placed in a room temperature 2.5 quart ceramic dish with a lid. Sample 4 was placed into a polymer shell that contained approximately ½ inch of insulation between the bottom and sides of Sample 4 and the shell. The shell and Sample 4 were then microwaved together for 120 seconds in a 1000 W microwave oven. The dish containing the green beans was positioned on top of Sample 4 (still housed in the shell) and temperature data was recorded. Results of this test are shown in FIG. 3H. As indicated in FIG. 3H, after 30 minutes the final temperature of the green beans was slightly warmer than in Example 5.

Example 7. In this example, frozen green beans were cooked in the microwave according to package directions in a 2.5 quart ceramic dish with a lid. Sample 1 was microwaved for 60 seconds in a 1000 W microwave oven, then placed on an approximately ½ inch thick piece of insulation. The dish containing the green beans was positioned on top of Sample 3 and temperature data was recorded. After 30 minutes the temperature of the green beans was greater than 150° F.

Example 8. In this example, Sample 5 was microwaved for 120 seconds in a 1000 W microwave oven, then placed on an approximately ½ inch thick piece of insulation. Temperature data was recorded and showed the maximum temperature of Sample 5 in the center and on a corner was similar to that of Sample 3 after Sample 3 had been subjected to the same microwaving procedure.

Example 9. In this example, Sample 6 was microwaved for 120 seconds in a 1000 W microwave oven, then placed on an approximately ½ inch thick piece of insulation. Temperature data showed the total energy absorbed by Sample 6 was similar to that of other samples containing a silicone matrix and subjected to the same microwaving procedure. Sample 7 was also microwaved for 120 seconds in a 1000 W microwave oven, then placed on an approximately ½ inch thick piece of insulation. Temperature data showed the total energy absorbed by Sample 7 was also similar to that of other samples containing a silicone matrix and subjected to the same microwaving procedure.

Example 10. Sample 8 was microwaved for 120 seconds in a 1000 W microwave oven, then placed on an approximately ½ inch thick piece of insulation. Temperature data was recorded in the center and on a corner of Sample 8. The temperature profile was similar to other Samples when subjected to the same microwaving procedure.

As the foregoing examples illustrate, the heating element 106 may be used with or without a housing (i.e., the housing 202 of FIGS. 2A and 2B). Moreover, regardless of whether the heating element 106 is positioned in a housing, the heating element 106 may also be used with or without an insulating layer 208.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A warming trivet, comprising:
a housing;
a heating element defining a heating contact surface, the heating element being arranged within the housing and made of a matrix material, a microwave susceptor suspended within the matrix material, and a filler material dispersed within the matrix material, the filler material exhibiting a susceptance lower than that of the susceptor material and a thermal conductivity greater than that of the matrix material; and
an insulation layer disposed between the heating element and the housing, the insulation layer being configured to insulate the housing from thermal energy emitted by the heating element.

2. The trivet of claim 1, wherein the housing comprises an upper frame and a base.

3. The trivet of claim 2, wherein the upper frame is coupled to the base using at least one of snap fits, mechanical fasteners, adhesives, and sonic welding.

4. The trivet of claim 1, wherein the housing is made of a material selected from the group consisting of phenol formaldehyde, syndiotactic polystyrene, polyphthalamide, silicone, polycyclohexylenedimethylene terephthalate, polyethylene terephthalate, polybutylene terephthalate, wood, cork, ceramics, and any combination thereof.

5. The trivet of claim 1, further comprising a top layer disposed on the heating element and exposed to a surrounding environment, the top layer defining a direct heating contact surface.

6. The trivet of claim 5, wherein the top layer is made of a microwave inactive material.

7. The trivet of claim 1, wherein the insulating layer is made of a material selected from the group consisting of glass wool, kaowool board, thermal ceramic blankets, glass foam, melamine foam, polyurethane foam, and fiber glass.

8. The trivet of claim 1, wherein the microwave susceptor material is at least one of a metal, a metal oxide, a metal sulfide, carbon, and a polymer.

9. The trivet of claim 1, wherein the matrix material is at least one of a thermosetting polymer, a thermoplastic polymer, an elastomer, and an inorganic matrix.

10. The trivet of claim 1, wherein the filler material is made of a material selected from the group consisting of magnesium oxide, aluminum oxide, zinc oxide, and steel mesh.

11. A heating element, comprising:
a matrix material;
a susceptor material suspended in the matrix material and being configured to absorb microwave radiation and convert the microwave radiation into thermal energy; and
a filler material dispersed within the matrix material and exhibiting a susceptance lower than that of the susceptor material and a thermal conductivity greater than that of the matrix material.

12. The heating element of claim 11, wherein the matrix material is at least one of a thermosetting polymer, a thermoplastic polymer, an elastomer, and an inorganic matrix.

13. The heating element of claim 11, wherein the matrix material is made of a material selected from the group consisting of polyphenylene sulfide, polycyclohexylene dimethylene terephthalate, syndiotactic polystyrene, silicone elastomer, polytetrafluoroethylene, fluoroelastomer, alumina, and cement.

14. The heating element of claim 11, wherein the susceptor material is at least one of a metal, a metal oxide, a metal sulfide, carbon, and a polymer.

15. The heating element of claim 11, wherein the susceptor material is made of a material selected from the group consisting of iron oxide, tin dioxide, copper oxide, silicon carbide, iron, aluminum, and carbon.

16. The heating element of claim 11, wherein the filler material comprises at least one of magnesium oxide, aluminum oxide, zinc oxide, and steel mesh.

17. The heating element of claim 11, further comprising a top layer disposed on a surface of the heating element and being made of a microwave inactive material.

18. A method, comprising:
introducing a heating element into a microwave, the heating element including a matrix material and a susceptor material suspended in the matrix material;
absorbing microwave radiation with the susceptor material;
converting the microwave radiation into thermal energy with the susceptor material;
placing a thermal mass on the heating element; and
transferring the thermal energy from the heating element to the thermal mass.

19. The method of claim 18, wherein the heating element is arranged within a trivet housing, and wherein introducing the heating element into the microwave comprises introducing the trivet housing into the microwave.

20. The method of claim 19, wherein the trivet housing includes an insulation layer disposed between the heating element and the housing, the method further comprising insulating the trivet housing from the thermal energy generated by the susceptor material with the insulation layer.

21. The method of claim 18, further comprising reducing an overall temperature of the heating element for a given amount of absorbed microwave radiation with the matrix material.

22. The method of claim 18, further comprising reducing an overall thermal conductivity of the heating element with the matrix material.

23. The method of claim 18, further comprising increasing an overall thermal conductivity of the heating element with a filler material suspended in the matrix material.

24. The method of claim 18, wherein a top layer is disposed on the heating element and placing the thermal mass on the heating element comprises placing the thermal mass on the top layer, the top layer being made of a microwave inactive material.

25. The method of claim 18, wherein the susceptor material is at least one of a metal, a metal oxide, a metal sulfide, carbon, and a polymer.

26. The method of claim 18, wherein the matrix material is at least one of a thermosetting polymer, a thermoplastic polymer, an elastomer, and an inorganic matrix.
